(19) United States
(12) Patent Application Publication
(10) Pub. No.: US 2022/0366606 A1
(43) Pub. Date: Nov. 17, 2022

(54) METHODS FOR CALIBRATING IMAGE ACQUIRING DEVICES, ELECTRONIC DEVICES AND STORAGE MEDIA

(71) Applicant: Shanghai SenseTime Lingang Intelligent Technology Co., Ltd., Shanghai (CN)

(72) Inventors: Tao MA, Shanghai (CN); Guohang YAN, Shanghai (CN); Yikang LI, Shanghai (CN)

(21) Appl. No.: 17/873,722

(22) Filed: Jul. 26, 2022

Related U.S. Application Data
(63) Continuation of application No. PCT/CN2021/102795, filed on Jun. 28, 2021.

(30) Foreign Application Priority Data
Dec. 22, 2020 (CN) 202011529925.7

(51) Int. Cl. G06T 7/80; G06T 7/60

(52) U.S. Cl. CPC G06T 7/80; G06T 7/60

(57) ABSTRACT

Methods, apparatus, electronic devices, and computer-readable storage media for calibrating image acquiring devices are provided. In one aspect, a computer-implemented method includes: obtaining a scene image of a preset scene acquired by an image acquiring device disposed on a traveling device, the preset scene including at least two parallel lines, the traveling device being located between adjacent two parallel lines, and sides of the traveling device being substantially parallel to the two parallel lines; based on the scene image, determining two line segments, and first coordinate information of a plurality of target reference points on each line segment of the two line segments in a pixel coordinate system and second coordinate information of the plurality of target reference points in a world coordinate system; and determining a homography matrix corresponding to the image acquiring device based on the first coordinate information and the second coordinate information.

### CROSS REFERENCE TO RELATED APPLICATIONS

This application is a continuation application of International Application No. PCT/CN2021/102795 filed on Jun. 28, 2021, which claims priority to a Chinese Patent Application No. 202011529925.7 filed on Dec. 22, 2020, the entire contents of which are incorporated herein by reference.

### TECHNICAL FIELD

The present disclosure relates to the technical field of computer vision, in particular to a method and an apparatus for calibrating image acquiring devices, an electronic device and a storage medium.

### BACKGROUND

With the development of science and technology, more and more vehicles are equipped with Advanced Driving Assistance System (ADAS). ADAS is usually integrated on an image acquiring device which can be installed by a user. The installation position and installation angle of the image acquiring device can be set according to requirements of the user. To ensure that functions of ADAS can be used normally after the image acquiring device is installed, it is necessary to calibrate the installed image acquiring device, that is, to determine a homography matrix of the installed image acquiring device.

### SUMMARY

In view of this, the present disclosure provides at least a method and an apparatus for calibrating image acquiring devices, an electronic device and a storage medium.

In a first aspect, the present disclosure provides a method for calibrating image acquiring devices, including:

obtaining a scene image of a preset scene acquired by an image acquiring device disposed on a traveling device, where the preset scene includes at least two parallel lines, the traveling device is located between adjacent two parallel lines among the at least two parallel lines, and sides of the traveling device are substantially parallel to the two parallel lines;

determining two line segments and a plurality of target reference points on each line segment of the two line segments based on the scene image, where the two line segments are respectively overlapped with two lines corresponding to the two parallel lines in the scene image;

determining, based on the scene image and for each line segment of the two line segments, first coordinate information of the plurality of target reference points on the line segment in a pixel coordinate system and second coordinate information of the plurality of target reference points on the line segment in a world coordinate system; and

determining a homography matrix corresponding to the image acquiring device based on the first coordinate information and the second coordinate information of the plurality of target reference points on each line segment of the two line segments.

With the above method, the first coordinate information of the plurality of target reference points on each of input at least two line segments in the pixel coordinate system and the second coordinate information of the plurality of target reference points in the world coordinate system are determined based on the obtained scene image, and the homography matrix corresponding to the image acquiring device can be determined by the first coordinate information and the second coordinate information, thus realizing the automatic calibration for the image acquiring device. Compared with the manual calibration method, the efficiency and accuracy of calibration are improved.

In an embodiment, before obtaining the scene image of the preset scene acquired by the image acquiring device disposed on the traveling device, the method further includes:

adjusting a position-orientation of the image acquiring device, such that a skyline included in the scene image acquired by the image acquiring device after the adjusting is located between a first reference line and a second reference line, where the first reference line and the second reference line are preset and located on a screen image of the image acquiring device when acquiring the scene image, and the first reference line and the second reference line are parallel on the screen image.

With the above method, the position-orientation of the image acquiring device can be adjusted before obtaining the scene image acquired by the image acquiring device, so that the skyline included in the scene image acquired by the image acquiring device after the adjustment is located between the set first reference line and the second reference line, that is, a pitch angle corresponding to the image acquiring device can be close to 0°. The situation where the accuracy of the generated second coordinate information of the target reference points is low due to a large pitch angle can be avoided, thus improving the accuracy of the homography matrix.

In an embodiment, before obtaining the scene image of the preset scene acquired by the image acquiring device disposed on the traveling device, the method further includes:

adjusting the position-orientation of the image acquiring device, such that the skyline included in the scene image acquired by the image acquiring device after the adjusting is overlapped with a third reference line between the first reference line and the second reference line, where the third reference line is located on the screen image of the image acquiring device when acquiring the scene image, and is parallel to the first reference line and the second reference line on the screen image.

In an embodiment, before obtaining the scene image of the preset scene acquired by the image acquiring device disposed on the traveling device, the method further includes:

adjusting a position-orientation of the image acquiring device, so that a skyline included in the scene image acquired by the image acquiring device after adjustment is parallel or overlapped with a reference line, where the reference line is located on a screen image of the image acquiring device when acquiring the scene image.

With the above method, the position-orientation of the image acquiring device can be adjusted before obtaining the scene image acquired by the image acquiring device, so that the skyline included in the scene image acquired by the image acquiring device after the adjustment is parallel or overlapped with the set third reference line, that is, a roll angle of the image acquiring device after the adjustment can be close to 0°. The situation where the accuracy of the generated second coordinate information of the target reference points is low due to a large roll angle can be avoided, thus improving the accuracy of the homography matrix.

In an embodiment, determining the two line segments and the plurality of target reference points on each line segment of the two line segments based on the scene image includes:

in a target area in the scene image, determining the two line segments overlapped with the two lines corresponding to the two parallel lines in the scene image, and the plurality of target reference points on each line segment of the two line segments.

Here, the target area can be in the scene image. A real distance between the two parallel lines in the target area and the image acquiring device is close. By selecting the plurality of target reference points on the two line segments overlapped with the two lines corresponding to the two parallel lines in the scene image from the target area, the second coordinate information of the selected target reference points can be determined accurately.

In an embodiment, determining, based on the scene image and for each line segment of the two line segments, first coordinate information of the plurality of target reference points on the line segment in a pixel coordinate system and second coordinate information of the plurality of target reference points on the line segment in a world coordinate system includes:

determining the first coordinate information of the plurality of target reference points in the pixel coordinate system corresponding to the scene image;

determining position coordinate information of an intersection of the two lines corresponding to the two parallel lines in the scene image in the pixel coordinate system based on the first coordinate information of the plurality of target reference points; and

determining the second coordinate information of the plurality of target reference points in the world coordinate system based on the position coordinate information of the intersection in the pixel coordinate system and the first coordinate information of the plurality of target reference points.

In an embodiment, determining the second coordinate information of the plurality of target reference points in the world coordinate system based on the position coordinate information of the intersection in the pixel coordinate system and the first coordinate information of the plurality of target reference points includes:

for each target reference point of the plurality of target reference points, determining information of a difference between the first coordinate information of the target reference point and the position coordinate information of the intersection; and determining the second coordinate information of the target reference point based on the information of the difference, focal length information of the image acquiring device and a predetermined installation height of the image acquiring device.

With the above method, for each target reference point, the second coordinate information of the target reference point is accurately determined through the calculated information of the difference between the first coordinate information of the target reference point and the position coordinate information of the intersection, the focal length information of the image acquiring device, and the installation height of the image acquiring device.

In an embodiment, the information of the difference between the first coordinate information of the target reference point and the position coordinate information of the intersection includes an abscissa difference and an ordinate difference, and determining the second coordinate information of the target reference point based on the information of the difference, the focal length information of the image acquiring device and the predetermined installation height of the image acquiring device includes:

determining a longitudinal coordinate value in the second coordinate information of the target reference point based on the ordinate difference, the predetermined installation height of the image acquiring device, and a longitudinal focal length in the focal length information of the image acquiring device; and

determining a horizontal coordinate value in the second coordinate information of the target reference point based on the longitudinal coordinate value, the abscissa difference, and a horizontal focal length in the focal length information of the image acquiring device.

In an embodiment, determining the horizontal coordinate value in the second coordinate information of the target reference point based on the longitudinal coordinate value, the abscissa difference, and the horizontal focal length in the focal length information of the image acquiring device includes:

determining a horizontal distance between the target reference point and the image acquiring device based on the longitudinal coordinate value, the abscissa difference, and the horizontal focal length in the focal length information of the image acquiring device; and

determining the horizontal coordinate value in the second coordinate information of the target reference point based on a determined horizontal distance between the image acquiring device and a center position of the traveling device, and the horizontal distance between the target reference point and the image acquiring device.

Considering that there is a horizontal distance between the image acquiring device and the center position of the traveling device (i.e., an origin of the constructed world coordinate system), after determining the horizontal distance between the target reference point and the image acquiring device, the horizontal coordinate value in the second coordinate information of the target reference point is accurately determined based on the determined horizontal distance between the image acquiring device and the center position of the traveling device, and the horizontal distance between the target reference point and the image acquiring device.

In an embodiment, after determining the homography matrix corresponding to the image acquiring device, the method further includes:

obtaining a real-time image acquired by the image acquiring device in a moving process of the traveling device;

determining world coordinate information of a target object included in the real-time image in the world coordinate system based on the homography matrix corresponding to the image acquiring device and detected pixel coordinate information of the target object; and

controlling the traveling device based on the world coordinate information of the target object.

With the above method, after the homography matrix corresponding to the image acquiring device is generated, the world coordinate information of the target object in the world coordinate system can be accurately determined by the determined homography matrix and detected pixel coordinate information of the target object included in the real-time image, thus realizing the accurate control of the traveling device.

For the description of effects of the following apparatus, electronic device, etc., please refer to the description of the above methods, which will not be repeated here.

In a second aspect, the present disclosure provides an apparatus for calibrating image acquiring devices, including:

an obtaining module, configured to obtain a scene image of a preset scene acquired by an image acquiring device disposed on a traveling device, where the preset scene includes at least two parallel lines, the traveling device is located between adjacent two parallel lines among the at least two parallel lines, and sides of the traveling device are substantially parallel to the two parallel lines;

a first determining module, configured to, based on the scene image, determine two line segments, and first coordinate information of a plurality of target reference points on each line segment of the two line segments in a pixel coordinate system and second coordinate information of the plurality of target reference points in a world coordinate system, where the two line segments are respectively overlapped with two lines corresponding to the two parallel lines in the scene image; and

a second determining module, configured to determine a homography matrix corresponding to the image acquiring device based on the first coordinate information and the second coordinate information of the plurality of target reference points on each line segment of the two line segments.

In a third aspect, the present disclosure provides an electronic device including at least one processor, at least one memory and a bus. The at least one memory stores machine-readable instructions executable by the at least one processor. When the electronic device operates, the at least one processor communicates with the at least one memory through the bus. When the machine-readable instructions are executed by the at least one processor, the steps of the method for calibrating the image acquiring devices described in the first aspect or any embodiment above are performed.

In a fourth aspect, the present disclosure provides a computer-readable storage medium having a computer program stored thereon. When the computer program is executed by a processor, the steps of the method for calibrating the image acquiring devices as described in the first aspect or any embodiment above are performed.

In order to make the above-mentioned objects, features and advantages of the present disclosure more obvious and understandable, the following some embodiments will be described in detail with reference to accompanying drawings.

### BRIEF DESCRIPTION OF THE DRAWINGS

To describe technical solutions in embodiments of the present disclosure more clearly, accompanying drawings required for describing the embodiments are briefly introduced below. The accompanying drawings here are incorporated into the specification and constitute a part of the specification. These accompanying drawings illustrate the embodiments in accordance with the present disclosure, and together with the description, serve to explain the technical solutions of the present disclosure. It should be understood that the following accompanying drawings only illustrate some embodiments of the present disclosure, and therefore should not be regarded as limiting the scope. For a person of ordinary skill in the art, other relevant drawings can be obtained according to these accompanying drawings without creative efforts.

FIG. 1 shows a flowchart illustrating a method for calibrating image acquiring devices according to an embodiment of the present disclosure.

FIG. 2 shows a schematic diagram illustrating a scene image in a method for calibrating image acquiring devices according to an embodiment of the present disclosure.

FIG. 3 shows a flowchart illustrating determining second coordinate information of a plurality of target reference points in a world coordinate system based on first coordinate information of the plurality of target reference points in a method for calibrating image acquiring devices according to an embodiment of the present disclosure.

FIG. 4 shows a schematic architecture diagram illustrating an apparatus for calibrating image acquiring devices according to an embodiment of the present disclosure.

FIG. 5 shows a schematic structural diagram illustrating an electronic device according to an embodiment of the present disclosure.

### DETAILED DESCRIPTION OF THE EMBODIMENTS

To make objectives, technical solutions and advantages of embodiments of the present disclosure more clear, the technical solutions in the embodiments of the present disclosure will be clearly and completely described below in combination with accompanying drawings in the embodiments of the present disclosure. Apparently, the described embodiments are only a part of the embodiments of the present disclosure, rather than all of the embodiments. Components of the embodiments of the present disclosure generally described and illustrated in the drawings herein can be arranged and designed in a variety of different configurations. Therefore, the following detailed description of the embodiments of the present disclosure provided in the accompanying drawings is not intended to limit the scope of the claimed present disclosure, but merely represents selected embodiments of the present disclosure. Based on the embodiments of the present disclosure, all other embodiments obtained by those skilled in the art without creative work shall fall within the protection scope of the present disclosure.

Generally, a user can determine a homography matrix of an installed image acquiring device by means of manual calibration. For example, the user can place a cone on the ground, determine the position of the cone, and determine the homography matrix of the installed image acquiring device based on the position of the cone. However, when the image acquiring device is calibrated by manual calibration, the operation process is complicated, and a large error will be generated when determining the position of the cone, resulting in a large error in the determined homography matrix, which will lead to inaccurate detection results of Advanced Driving Assistance System (ADAS). To improve the accuracy of the calibration of the image acquiring device and accurately determine the homography matrix corresponding to the image acquiring device, the embodiments of the present disclosure provide a method and an apparatus for calibrating image acquiring devices, an electronic device and a storage medium.

The technical solutions in the present disclosure will be clearly and completely described below in combination with the accompanying drawings in the present disclosure. Apparently, the described embodiments are only a part of the embodiments of the present disclosure, rather than all of the embodiments. The components of the present disclosure generally described and illustrated in the drawings herein can be arranged and designed in a variety of different configurations. Therefore, the following detailed description of the embodiments of the present disclosure provided in the accompanying drawings is not intended to limit the scope of the claimed present disclosure, but merely represents selected embodiments of the present disclosure. Based on the embodiments of the present disclosure, all other embodiments obtained by those skilled in the art without creative work shall fall within the protection scope of the present disclosure.

It should be noted that like numerals and letters indicate like items in the following drawings. Therefore, once an item is defined in a drawing, it does not need to be further defined and explained in subsequent drawings.

In order to facilitate the understanding of the embodiments of the present disclosure, a method for calibrating image acquiring devices disclosed in the embodiments of the present disclosure is first introduced in detail. The execution subject of the method for calibrating the image acquiring devices provided by the embodiments of the present disclosure is generally a computer device with certain computing capability. The computer device includes, for example, a terminal device, a server or other processing devices. The terminal device can be user equipment (UE), a mobile device, a user terminal, a terminal, a cellular phone, a cordless phone, a personal digital assistant (PDA), a handheld device, a computing device, an on-board device, a wearable device, etc. In some possible implementations, the method for calibrating the image acquiring devices can be implemented by a processor calling computer-readable instructions stored in a memory. The image acquiring device refers to any device capable of acquiring/capturing images, such as a camera, a video camera, monitoring equipment, and a device incorporating or connecting with a camera, which is not restricted in the disclosure.

Referring to FIG. 1, which is a flowchart illustrating a method for calibrating image acquiring devices according to an embodiment of the present disclosure. The method includes S101-S103.

S101: a scene image of a preset scene acquired by an image acquiring device disposed on a traveling device is obtained, where the preset scene includes at least two parallel lines, the traveling device is located between adjacent two parallel lines among the at least two parallel lines, and sides of the traveling device are parallel to the two parallel lines. In the preset scene, the parallel lines mean that the lines are actually parallel. But in the scene image, due to the constitution and imaging principle of the image acquiring device, there is a certain angle formed between the two parallel lines, that is, the two parallel lines intersect at a certain point.

S102: two line segments, and first coordinate information of a plurality of target reference points on each line segment of the two line segments in a pixel coordinate system and second coordinate information of the plurality of target reference points in a world coordinate system are determined based on the scene image, where the two line segments are respectively overlapped with two lines corresponding to the two parallel lines in the scene image.

S103: a homography matrix corresponding to the image acquiring device is determined based on the first coordinate information and the second coordinate information.

In the above method, the two line segments, and the first coordinate information of the plurality of target reference points on each line segment in the pixel coordinate system and the second coordinate information of the plurality of target reference points in the world coordinate system are determined based on the obtained scene image, and the homography matrix corresponding to the image acquiring device can be determined by the first coordinate information and the second coordinate information, thus realizing the automatic calibration for the image acquiring device. Compared with the manual calibration method, the efficiency and accuracy of calibration are improved.

S101-S103 are described in detail below.

For S101:

Here, the traveling device can be a motor vehicle, a non-motor vehicle, a robot, etc., and the image acquiring device can be installed on the traveling device. After the image acquiring device is installed, the scene image of the preset scene acquired by the image acquiring device is obtained. The preset scene includes the at least two parallel lines (i.e., at least two lines that are parallel to each other), the traveling device is located between the adjacent two parallel lines (i.e., two lines that are parallel to each other) among the at least two parallel lines, and the sides of the traveling device are substantially parallel to the adjacent two parallel lines. The term “substantially parallel” in the present disclosure indicates that an angle between the adjacent two parallel lines and the sides of the traveling device is within a range, for example, from 0° to 10°. By controlling the sides of the traveling device to be parallel to the two parallel lines, a yaw angle corresponding to the image acquiring device can be close to 0° (that is, a difference between the yaw angle corresponding to the image acquiring device and 0° is less than a set first difference threshold), and thus the second coordinate information of the target reference points can be accurately determined based on the acquired scene image corresponding to the preset scene.

For example, the two parallel lines can be road traffic markings set on a road, for example, any one of the two parallel lines can be a white solid line, a white dashed line, a yellow solid line, etc. on the road. In some embodiments, the two parallel lines can also be two parallel lines drawn for a parking space. For example, the preset scene can be any scene with at least two road markings (i.e., two parallel lines) and a visible skyline (the so-called skyline is a boundary line between heaven and earth). For example, the preset scene can be a road scene or a parking lot scene.

Before obtaining the scene image of the preset scene, a position-orientation of the image acquiring device can be adjusted in the following three manners, so that the second coordinate information of the target reference points can be determined based on the scene image of the preset scene acquired by the image acquiring device after adjustment, thus improving the accuracy of the determined second coordinate information.

Manner 1: before obtaining the scene image of the preset scene acquired by the image acquiring device disposed on the traveling device, the method further includes: adjusting the position-orientation of the image acquiring device, so that a skyline included in the scene image acquired by the image acquiring device after adjustment is located between a set first reference line and a set second reference line, where the first reference line and the second reference line are located on a screen image of the image acquiring device when acquiring the scene image, and the first reference line and the second reference line are parallel. Here, the screen image may also be construed as a screen presented on the image acquiring device when capturing the scene image.

Here, considering a correlation between a pitch angle of the image acquiring device and the second coordinate information of the target reference points, to accurately determine the second coordinate information of the target reference points, the position-orientation of the image acquiring device can be adjusted, so that the skyline included in the scene image acquired by the image acquiring device after the adjustment is located between the set first reference line and the second reference line, that is, the pitch angle corresponding to the image acquiring device after the adjustment is close to 0° (for example, a difference between the pitch angle corresponding to the image acquiring device and 0° is less than a second difference threshold). For example, positions of the first reference line and the second reference line on the screen image can be determined according to actual conditions.

With the above manner, the situation where the accuracy of the generated second coordinate information of the target reference points is low due to a large pitch angle can be avoided, thus improving the accuracy of the homography matrix.

Manner 2: before obtaining the scene image of the preset scene acquired by the image acquiring device disposed on the traveling device, the method further includes: adjusting the position-orientation of the image acquiring device, so that the skyline included in the scene image acquired by the image acquiring device after adjustment is parallel or overlapped with a set third reference line, where the third reference line is located on the screen image of the image acquiring device when acquiring the scene image.

Here, considering a correlation between a roll angle of the image acquiring device and the second coordinate information of the target reference points, to accurately determine the second coordinate information of the target reference points, the third reference line can be set on the screen image of the image acquiring device when acquiring the scene image, and the position-orientation of the image acquiring device can be adjusted, so that the skyline in the scene image acquired by the image acquiring device after the adjustment is parallel or overlapped with the set third reference line, that is, the roll angle of the image acquiring device is close to 0° (for example, a difference between the roll angle of the image acquiring device and 0° is less than a set third difference threshold). The position of the third reference line on the screen image can be determined according to actual conditions.

With the above manner, the situation where the accuracy of the generated second coordinate information of the target reference points is low due to a large roll angle can be avoided, thus improving the accuracy of the homography matrix.

Manner 3: before obtaining the scene image of the preset scene acquired by the image acquiring device disposed on the traveling device, the method further includes:

adjusting the position-orientation of the image acquiring device, so that the skyline included in the scene image acquired by the image acquiring device after adjustment is overlapped with a fourth reference line between the first reference line and the second reference line, where the fourth reference line is located on the screen image of the image acquiring device when acquiring the scene image, between the first reference line and the second reference line, and parallel to the first reference line and the second reference line.

Here, the first reference line, the second reference line and the fourth reference line that are parallel to each other can be set on the screen image of the image acquiring device when acquiring the scene image, where the fourth reference line is located between the first reference line and the second reference line. Positions of the first reference line, the second reference line and the fourth reference line on the screen image can be set according to the actual conditions. Furthermore, the position-orientation of the image acquiring device can be adjusted, so that the skyline included in the scene image acquired by the image acquiring device after the adjustment is overlapped with the set fourth reference line, that is, the pitch angle and roll angle of the image acquiring device can be close to 0°.

For S102:

After obtaining the scene image, the first coordinate information of the plurality of target reference points on the scene image in the pixel coordinate system can be determined, and then the second coordinate information of the plurality of target reference points in the world coordinate system can be determined based on the first coordinate information of the plurality of target reference points. An origin of the world coordinate system can be selected as required. For example, the world coordinate system can be a coordinate system constructed with a center point of the traveling device as an origin, or can also be a coordinate system constructed with a center point of a top plane of the traveling device as an origin. In some embodiments, the world coordinate system can also be a coordinate system constructed with the image acquiring device as an origin.

In an embodiment, the two line segments and the plurality of target reference points on each line segment are determined by: in a target area in the scene image, determining the two line segments overlapped with the two lines corresponding to the two parallel lines in the scene image, and the plurality of target reference points on each line segment of the two line segments.

Here, the target area can be set as required. For example, the target area can be an image area located in a middle of the scene image, and/or the target area can be an image area including the two lines corresponding to the two parallel lines in the scene image. Since the second coordinate information of pixel points cannot be accurately determined w % ben a real distance between a real object indicated by the pixel points in the scene image and the image acquiring device is far, the distance between the real object corresponding to the pixel points in the target area and the image acquiring device is less than a set distance threshold.

The target area can also be automatically set according to the size of the scene image. For example, a lower part which occupies a predetermined proportion in the scene image can be automatically set as the target area, and whether the target area includes the at least two road markings can be automatically determined. If the target area does not include two road markings, the target area can be automatically expanded; or it is prompted that the scene image is wrong, and the scene image needs to be re-acquired.

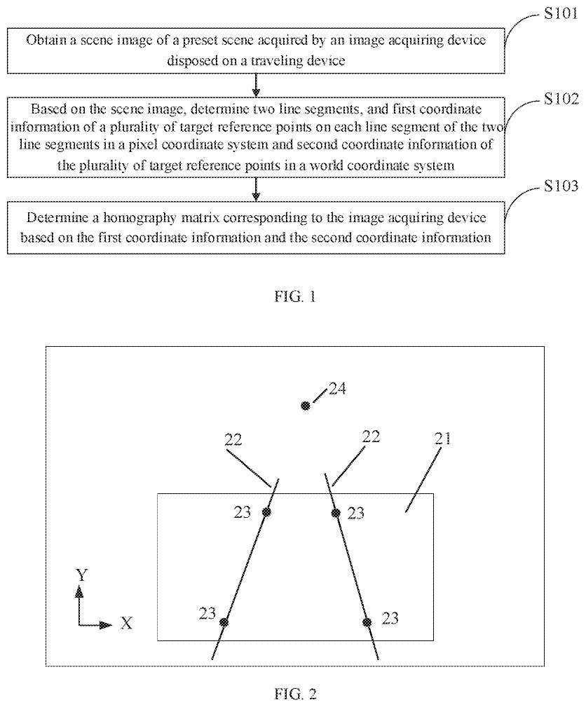

In an embodiment, the two line segments overlapped with the two lines corresponding to the two parallel lines in the scene image can be determined from the target area in the scene image, and four target reference points can be selected on the two line segments. Referring to a schematic diagram of a scene image in a method for calibrating image acquiring devices shown in FIG. 2, which includes a target area 21, parallel lines 22, and a plurality of target reference points 23 determined in the target area.

Here, the target area can be set in the scene image, where the real distance between the two parallel lines corresponding to the two lines in the target area and the image acquiring device is close. By determining the two line segments overlapped with the two lines corresponding to the two parallel lines in the scene image and the plurality of target reference points on the two line segments from the target area, the second coordinate information of the selected target reference points can be determined accurately.

In an embodiment, lengths of the two line segments are related to the size of the target area. For example, the lengths of the two line segments can be automatically determined according to a length of the target area. For another example, the lengths of the two line segments can be automatically determined according to lengths of the road markings detected in the target area. For another example, the lengths of the two line segments can be set according to empirical values.

In an example, after determining the lengths of the two line segments, the two line segments can be automatically moved to be overlapped with the detected parallel lines. In another example, the two line segments can be manually adjusted to be overlapped with the parallel lines more closely.

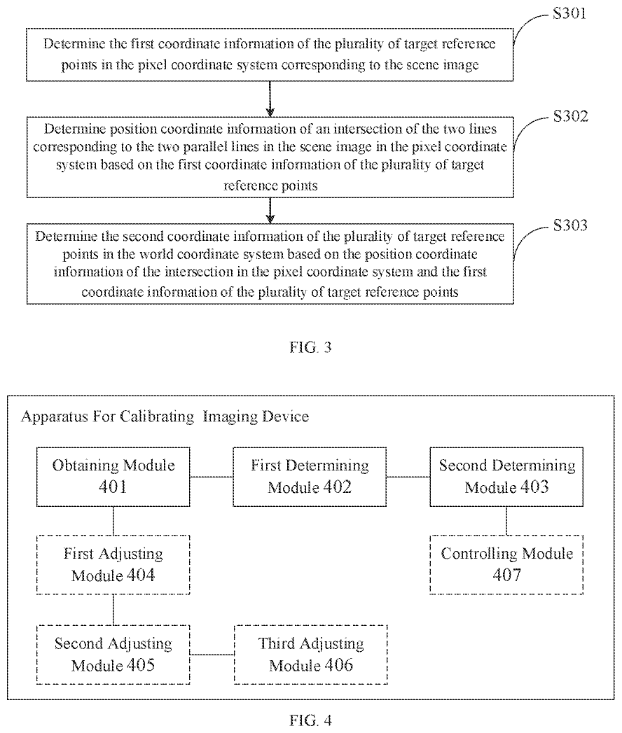

In an embodiment, as shown in FIG. 3, based on the scene image, determining the two line segments, and the first coordinate information of the plurality of target reference points on each line segment in the pixel coordinate system and the second coordinate information of the plurality of target reference points in the world coordinate system includes:

S301: determining the first coordinate information of the plurality of target reference points in the pixel coordinate system corresponding to the scene image;

S302: determining position coordinate information of an intersection of the two lines corresponding to the two parallel lines in the scene image in the pixel coordinate system based on the first coordinate information of the plurality of target reference points. The intersection corresponds to a point where the two parallel lines between which the traveling device is located merge and vanish visually.

S303: determining the second coordinate information of the plurality of target reference points in the world coordinate system based on the position coordinate information of the intersection in the pixel coordinate system and the first coordinate information of the plurality of target reference points.

In S301 and S302, the first coordinate information of each selected target reference point in the pixel coordinate system corresponding to the scene image can be determined. Then, based on the first coordinate information of the plurality of target reference points, fitting parameters of the lines where the target reference points are located can be determined. Then, the position coordinate information of the intersection of the two lines corresponding to the two parallel lines in the scene image in the pixel coordinate system can be determined by the determined fitting parameters of the two lines.

Illustrative explanation is made with reference to FIG. 2, FIG. 2 also includes two lines 22 (namely, a first line and a second line) corresponding to the two parallel lines in the scene image, and an intersection 24 corresponding to the first line and the second line. In FIG. 2, the number of selected target reference points 23 can be four. Two target reference points 23 on the left are located on the first line, and two target reference points 23 on the right are located on the second line.

It can be understood that, since the two line segments are overlapped with the two lines respectively, the two line segments are not shown in FIG. 2. In an embodiment, the target reference points may be end points of each line segment.

For example, the first coordinate information of a first target reference point on the left is (x1, y1), the first coordinate information of a second target reference point on the left is (x2, y2), the first coordinate information of a third target reference point on the right is (x3, y3), and the first coordinate information of a fourth target reference point on the right is (x4, y4). Then, a first linear equation (1) corresponding to the first line can be obtained;

$${Y}_{left} = \frac{{y}_{2} - {y}_{1}}{{x}_{2} - {x}_{1}} ( X - {x}_{1} ) + {y}_{1} ; \qquad ( 1 )$$

a second linear equation 2 corresponding to the second line can be obtained:

$${Y}_{right} = \frac{{y}_{4} - {y}_{3}}{{x}_{4} - {x}_{3}} ( X - {x}_{3} ) + {y}_{3} . \qquad ( 2 )$$

Further, the position coordinate information of the intersection in the pixel coordinate system can be determined by the first linear equation (1) of the first line and the second linear equation (2) of the second line. Where an abscissa VPₓ in the position coordinate information of the determined intersection in the pixel coordinate system is.

$$V {P}_{x} = \frac{( {x}_{4} - {x}_{3} ) ( {x}_{1} {y}_{2} - {x}_{2} {y}_{1} ) - ( {x}_{2} - {x}_{1} ) ( {x}_{3} {y}_{4} - {x}_{4} {y}_{3} )}{( {x}_{4} - {x}_{3} ) ( {y}_{2} - {y}_{1} ) - ( {x}_{2} - {x}_{1} ) ( {y}_{4} - {y}_{3} )} ;$$

an ordinate VP_{y} in the position coordinate information of the determined intersection in the pixel coordinate system is:

$$V {P}_{y} = ( \frac{( {x}_{4} - {x}_{3} ) ( {x}_{1} {y}_{2} - {x}_{2} {y}_{1} ) - ( {x}_{2} - {x}_{1} ) ( {x}_{3} {y}_{4} - {x}_{4} {y}_{3} )}{( {x}_{4} - {x}_{3} ) ( {y}_{2} - {y}_{1} ) - ( {x}_{2} - {x}_{1} ) ( {y}_{4} - {y}_{3} )} - {x}_{1} ) \times \frac{{y}_{2} - {y}_{1}}{{x}_{2} - {x}_{1}} + {y}_{1} .$$

That is, the position coordinate information (VPₓ, VP_{y}) of the intersection in the pixel coordinate system is obtained.

In another specific embodiment, more than two first target reference points can be selected from the first line in FIG. 2, and the first linear equation corresponding to the first line can be determined (that is, first fitting parameters corresponding to the first line are determined) by linearly fitting the first coordinate information of the selected plurality of first target reference points in the pixel coordinate system; and more than two second target reference points can be selected from the second line, and the second linear equation corresponding to the second line can be determined (that is, second fitting parameters corresponding to the second line are determined) by linearly fitting the first coordinate information of the selected plurality of second target reference points in the pixel coordinate system. The number of the selected first target reference points or the second target reference points can be set as required, for example, four first target reference points can be selected from the first line and four second target reference points can be selected from the second line.

In an example, the selected plurality of first target reference points can be fitted by the least square method to determine the first fitting parameters corresponding to the first line, that is, to obtain the first linear equation corresponding to the first line; and the selected plurality of second target reference points can be fitted by the least square method to determine the second fitting parameters corresponding to the second line, that is, to obtain the second linear equation corresponding to the second line.

Further, the position coordinate information of the intersection of the two lines (i.e., the first line and the second line) corresponding to the two parallel lines in the scene image in the pixel coordinate system can be determined by the first linear equation corresponding to the first line and the second linear equation corresponding to the second line.

In S303, in an embodiment, determining the second coordinate information of the plurality of target reference points based on the position coordinate information of the intersection in the pixel coordinate system and the first coordinate information of the plurality of target reference points includes: for each target reference point, calculating information of a difference between the first coordinate information of the target reference point and the position coordinate information of the intersection; and determining the second coordinate information of the target reference point based on the information of the difference, focal length information of the image acquiring device and an installation height of the image acquiring device that is determined in advance.

In specific implementation, for each target reference point, the information of the difference between the first coordinate information of the target reference point and the position coordinate information of the intersection is first calculated, that is, an abscissa of the target reference point can be compared with the abscissa of the intersection to obtain an abscissa difference between the target reference point and the intersection, and an ordinate of the target reference point can be compared with the ordinate of the intersection to obtain an ordinate difference between the target reference point and the intersection.

Then, the second coordinate information of the target reference point is determined by the determined information of the difference, the focal length information of the image acquiring device, and the installation height of the image acquiring device that is determined in advance. The focal length information of the image acquiring device may include a longitudinal focal length and a horizontal focal length. The installation height of the image acquiring device is a height distance between the image acquiring device and the ground.

With the above method, for each target reference point, the second coordinate information of the target reference point is accurately determined through the calculated information of the difference between the first coordinate information of the target reference point and the position coordinate information of the intersection, the focal length information of the image acquiring device, and the installation height of the image acquiring device.

In an embodiment, the information of the difference between the first coordinate information of the target reference point and the position coordinate information of the intersection includes the abscissa difference and the ordinate difference; determining the second coordinate information of the target reference point based on the information of the difference, the focal length information of the image acquiring device and the installation height of the image acquiring device that is determined in advance includes:

determining a longitudinal coordinate value in the second coordinate information of the target reference point based on the ordinate difference, the installation height of the image acquiring device and the longitudinal focal length in the focal length information of the image acquiring device; and determining a horizontal coordinate value in the second coordinate information of the target reference point based on the longitudinal coordinate value, the abscissa difference, and the horizontal focal length in the focal length information of the image acquiring device.

A longitudinal distance between the target reference point and the image acquiring device can be determined according to the following formula (3):

$$D {Y}_{i} = \frac{{f}_{y}}{abs ( {VP}_{y} - {y}_{i} )} * {camera}_{H} ; \qquad ( 3 )$$

where, DYᵢ is the longitudinal distance between a i^{th} target reference point and the image acquiring device, abs(VP_{y}−yᵢ) is an absolute value of the ordinate difference corresponding to the i^{th} target reference point, f_{y} is the longitudinal focal length, and camera_{H} is the installation height of the image acquiring device.

Further, the longitudinal coordinate value in the second coordinate information of the target reference point can be determined based on the longitudinal distance between the target reference point and the image acquiring device. For example, when the image acquiring device is located on a horizontal coordinate axis of the world coordinate system, the determined longitudinal distance between the target reference point and the image acquiring device is the longitudinal coordinate value. When there is a longitudinal distance between the image acquiring device and a horizontal coordinate axis of the world coordinate system, the longitudinal coordinate value in the second coordinate information of the target reference point can be determined based on the longitudinal distance between the image acquiring device and the horizontal coordinate axis of the world coordinate system, and the determined longitudinal distance between the target reference point and the image acquiring device.

Considering that the origin of the constructed world coordinate system may be consistent or inconsistent with an installation position of the image acquiring device, a horizontal distance between the target reference point and the image acquiring device can be determined first, and then the horizontal coordinate value in the second coordinate information of the target reference point can be determined by the determined horizontal distance between the target reference point and the image acquiring device, and a horizontal distance between the image acquiring device and the origin.

In an embodiment, determining the horizontal coordinate value in the second coordinate information of the target reference point based on the longitudinal coordinate value, the abscissa difference, and the horizontal focal length in the focal length information of the image acquiring device includes:

determining the horizontal distance between the target reference point and the image acquiring device based on the longitudinal coordinate value, the abscissa difference, and the horizontal focal length in the focal length information of the image acquiring device; and determining the horizontal coordinate value in the second coordinate information of the target reference point based on a determined horizontal distance between the image acquiring device and a center position of the traveling device, and the horizontal distance between the target reference point and the image acquiring device.

The horizontal distance between the target reference point and the image acquiring device can be determined according to the following formula (4):

$${DX}_{i} = \frac{abs ( {VP}_{x} - {x}_{i} )}{{f}_{x}} * D {Y}_{i} ; \qquad ( 4 )$$

where, DXᵢ is the horizontal coordinate value of the i^{th} target reference point in the world coordinate system, abs(VPₓ−xᵢ) is an absolute value of the abscissa difference corresponding to the i^{th} target reference point, fₓ is the horizontal focal length, DYᵢ is the longitudinal coordinate value of the i^{th} target reference point in the world coordinate system.

After determining the horizontal distance between the target reference point and the image acquiring device, the horizontal coordinate value in the second coordinate information of the target reference point can be determined by the determined horizontal distance between the target reference point and the image acquiring device, and the horizontal distance between the image acquiring device and the origin of the constructed world coordinate system. When the origin of the constructed world coordinate system is the center position of the traveling device, the horizontal distance between the image acquiring device and the origin of the constructed world coordinate system is the horizontal distance between the image acquiring device and the center position of the traveling device.

In an example, through the above process, the second coordinate information of the four target reference points shown in FIG. 2 can be obtained, that is, the second coordinate information (X1, Y1) of the first target reference point on the left, the second coordinate information (X2, Y2) of the second target reference point on the left, the second coordinate information (X3, Y3) of the third target reference point on the right, and the second coordinate information (X4, Y4) of the fourth target reference point on the right can be obtained.

Considering that there is a horizontal distance between the image acquiring device and the center position of the traveling device (i.e., the origin of the constructed world coordinate system), after determining the horizontal distance between the target reference point and the image acquiring device, the horizontal coordinate value in the second coordinate information of the target reference point is accurately determined based on the determined horizontal distance between the image acquiring device and the center position of the traveling device, and the horizontal distance between the target reference point and the image acquiring device.

For S103:

The homography matrix corresponding to the image acquiring device can be determined based on the first coordinate information and the second coordinate information.

In an example, the homography matrix can be determined according to the following formula (5):

H=(AA^{T})*(CA^{T})⁻¹ (5);

where, H is the homography matrix corresponding to the image acquiring device,

$$C = [ \begin{matrix}{x}_{1} & … & {x}_{n} \\ {y}_{1} & … & {y}_{n} \\ 1 & … & 1\end{matrix} ] ,$$

C is a first matrix formed by the first coordinate information of the plurality of target reference points,

$$A = [ \begin{matrix}{X}_{1} & … & {X}_{n} \\ {Y}_{1} & … & {Y}_{n} \\ 1 & … & 1\end{matrix} ] ,$$

A is a second matrix formed by the second coordinate information of the plurality of target receference points. A^{T} is a matrix transpose of A.

In an embodiment, after determining the homography matrix corresponding to the image acquiring device, the method further includes: obtaining a real-time image acquired by the image acquiring device in a moving process of the traveling device; determining world coordinate information of a target object included in the real-time image in the world coordinate system based on the homography matrix corresponding to the image acquiring device and detected pixel coordinate information of the target object; and controlling the traveling device based on the world coordinate information of the target object.

Here, after the homography matrix corresponding to the target image acquiring device is determined, the real-time image acquired by the target image acquiring device can be obtained in the moving process of the traveling device, the acquired real-time image can be detected, and position information of the target object included in the real-time image in the pixel coordinate system can be determined. Then, the world coordinate information of the target object in the world coordinate system can be determined by the determined homography matrix and the determined position information of the target object in the pixel coordinate system. Finally, the traveling device can be controlled based on the world coordinate information of the target object. For example, acceleration, deceleration, steering, braking, etc. of the traveling device can be controlled; or voice prompt information can be played to prompt the driver to control the acceleration, deceleration, steering, braking, etc. of the traveling device.

In an example, after determining the position information of the target object included in the real-time image in the pixel coordinate system, the world coordinate information of the target object in the world coordinate system can also be determined by the determined homography matrix, the position coordinate information of the intersection in the pixel coordinate system, and the determined position information of the target object in the pixel coordinate system. Finally, the traveling device is controlled based on the world coordinate information of the target object, which provides a good foundation for subsequent work of ADAS such as lane line detection, obstacle detection, traffic sign recognition and navigation, for example.

With the above method, the world coordinate information of the target object in the world coordinate system can be accurately determined, thus realizing the accurate control of the traveling device.

Those skilled in the art can understand that, in the above method of the specific embodiments, the writing order of each step does not mean a strict execution order to constitute any limitation on the implementation process. The specific execution order of each step should be determined according to the function and possible internal logic.

Based on the same concept, the embodiments of the present disclosure also provide an apparatus for calibrating image acquiring devices. As shown in FIG. 4, which is a schematic architecture diagram illustrating an apparatus for calibrating image acquiring devices according to an embodiment of the present disclosure, the apparatus includes an obtaining module 401, a first determining module 402 and a second determining module 403.

The obtaining module 401 is configured to obtain a scene image of a preset scene acquired by an image acquiring device disposed on a traveling device, where the preset scene includes at least two parallel lines, the traveling device is located between adjacent two parallel lines among the at least two parallel lines, and sides of the traveling device are parallel to the two parallel lines.

The first determining module 402 is configured to, based on the scene image, determine two line segments, and first coordinate information of a plurality of target reference points on each line segment of the two line segments in a pixel coordinate system and second coordinate information of the plurality of target reference points in a world coordinate system, where the two line segments are respectively overlapped with two lines corresponding to the two parallel lines in the scene image.

The second determining module 403 is configured to determine a homography matrix corresponding to the image acquiring device based on the first coordinate information and the second coordinate information.

In an embodiment, the apparatus further includes a first adjusting module 404, configured to, before the scene image of the preset scene acquired by the image acquiring device disposed on the traveling device is obtained,

adjust a position-orientation of the image acquiring device, so that a skyline included in the scene image acquired by the image acquiring device after adjustment is located between a set first reference line and a set second reference line, where the first reference line and the second reference line are located on a screen image of the image acquiring device when acquiring the scene image, and the first reference line and the second reference line are parallel on the screen image.

In an embodiment, the apparatus further includes a second adjusting module 405, configured to, before the scene image of the preset scene acquired by the image acquiring device disposed on the traveling device is obtained,

adjust a position-orientation of the image acquiring device, so that a skyline included in the scene image acquired by the image acquiring device after adjustment is parallel or overlapped with a set third reference line, where the third reference line is located on a screen image of the image acquiring device when acquiring the scene image.

In an embodiment, the apparatus further includes a third adjusting module 406, configured to, before the scene image of the preset scene acquired by the image acquiring device disposed on the traveling device is obtained,

adjust the position-orientation of the image acquiring device, so that the skyline included in the scene image acquired by the image acquiring device after adjustment is overlapped with a fourth reference line between the first reference line and the second reference line, where the fourth reference line is located on the screen image of the image acquiring device when acquiring the scene image, and is parallel to the first reference line and the second reference line on the screen image.

In an embodiment, the first determining module 402 is configured to determine the two line segments and the plurality of target reference points on each line segment according to the following method:

in a target area in the scene image, determining the two line segments overlapped with the two lines corresponding to the two parallel lines in the scene image, and the plurality of target reference points on each line segment of the two line segments.

In an embodiment, when based on the scene image, determining the two line segments, and the first coordinate information of the plurality of target reference points on each line segment in the pixel coordinate system and the second coordinate information of the plurality of target reference points in the world coordinate system, the first determining module 402 is configured to:

determine the first coordinate information of the plurality of target reference points in the pixel coordinate system corresponding to the scene image;

determine position coordinate information of an intersection of the two lines corresponding to the two parallel lines in the scene image in the pixel coordinate system based on the first coordinate information of the plurality of target reference points; and

determine the second coordinate information of the plurality of target reference points in the world coordinate system based on the position coordinate information of the intersection in the pixel coordinate system and the first coordinate information of the plurality of target reference points.

In an embodiment, when determining the second coordinate information of the plurality of target reference points in the world coordinate system based on the position coordinate information of the intersection in the pixel coordinate system and the first coordinate information of the plurality of target reference points, the first determining module 402 is configured to:

for each target reference point of the plurality of target reference points, determine information of a difference between the first coordinate information of the target reference point and the position coordinate information of the intersection; and determine the second coordinate information of the target reference point based on the information of the difference, focal length information of the image acquiring device and an installation height of the image acquiring device that is determined in advance.

In an embodiment, the information of the difference between the first coordinate information of the target reference point and the position coordinate information of the intersection includes an abscissa difference and an ordinate difference; when determining the second coordinate information of the target reference point based on the information of the difference, the focal length information of the image acquiring device and the installation height of the image acquiring device that is determined in advance, the first determining module 402 is configured to:

determine a longitudinal coordinate value in the second coordinate information of the target reference point based on the ordinate difference, the installation height of the image acquiring device, and a longitudinal focal length in the focal length information of the image acquiring device; and

determine a horizontal coordinate value in the second coordinate information of the target reference point based on the longitudinal coordinate value, the abscissa difference, and a horizontal focal length in the focal length information of the image acquiring device.

In an embodiment, when determining the horizontal coordinate value in the second coordinate information of the target reference point based on the longitudinal coordinate value, the abscissa difference, and the horizontal focal length in the focal length information of the image acquiring device, the first determining module 402 is configured to:

determine a horizontal distance between the target reference point and the image acquiring device based on the longitudinal coordinate value, the abscissa difference, and the horizontal focal length in the focal length information of the image acquiring device; and

determine the horizontal coordinate value in the second coordinate information of the target reference point based on a determined horizontal distance between the image acquiring device and a center position of the traveling device, and the horizontal distance between the target reference point and the image acquiring device.

In an embodiment, the apparatus further includes a controlling module 407, configured to, after the homography matrix corresponding to the image acquiring device is determined,

obtain a real-time image acquired by the image acquiring device in a moving process of the traveling device;

determine world coordinate information of a target object included in the real-time image in the world coordinate system based on the homography matrix corresponding to the image acquiring device and detected pixel coordinate information of the target object; and

control the traveling device based on the world coordinate information of the target object.

In some embodiments, functions or modules of the apparatus provided by the embodiments of the present disclosure can be used to perform the methods described in the above method embodiments, and the specific implementation can refer to the descriptions in the above method embodiments, which will not be repeated here for brevity.

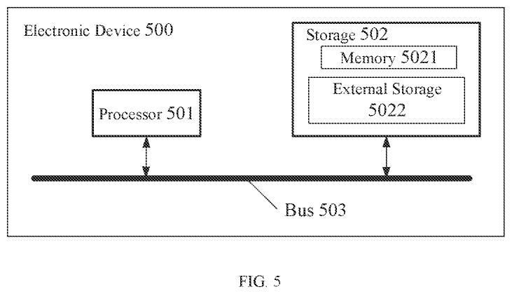

Based on the same technical concept, the embodiments of the present disclosure also provide an electronic device. Referring to FIG. 5, which is a schematic structural diagram illustrating an electronic device according to an embodiment of the present disclosure. The electronic device includes a processor 501, a storage 502, and a bus 503. The storage 502 is configured to store execution instructions, and includes a memory 5021 and an external storage 5022. The memory 5021 here is also called an internal storage, and is configured to temporarily store operation data in the processor 501 and data exchanged with the external storage 5022 such as a hard disk. The processor 501 exchanges data with the external storage 5022 through the memory 5021. When the electronic device 500 is running, the processor 501 communicates with the storage 502 through the bus 503, so that the processor 501 executes the following instructions:

obtaining a scene image of a preset scene acquired by an image acquiring device disposed on a traveling device;

based on the scene image, determining first coordinate information of a plurality of target reference points on each line segment of input at least two line segments in a pixel coordinate system and second coordinate information of the plurality of target reference points in a world coordinate system, where the two at least line segments with target reference points are respectively overlapped with two lines corresponding to two parallel lines between which the traveling device is located in the scene image; and

determining a homography matrix corresponding to the image acquiring device based on the first coordinate information and the second coordinate information.

In addition, the embodiments of the present disclosure also provide a computer-readable storage medium having a computer program stored thereon, when the computer program is executed by a processor, the steps of the methods for calibrating the image acquiring devices described in the above method embodiments are performed. The storage medium may be a volatile or nonvolatile computer-readable storage medium.

The embodiments of the present disclosure also provide a computer program product, which carries program codes, and instructions included in the program codes can be used to perform the steps of the methods for calibrating the image acquiring devices described in the above method embodiments. For details, please refer to the above method embodiments, which will not be repeated here.

The computer program product can be specifically implemented by hardware, software or a combination thereof. In an embodiment, the computer program product is specifically embodied as a computer storage medium. In another embodiment, the computer program product is specifically embodied as a software product, such as a software development kit (SDK).

Those skilled in the art can clearly understand that for the convenience and conciseness of the description, the specific working process of the apparatus and device described above can refer to the corresponding process in the above method embodiments, and will not be repeated here. In several embodiments provided by the present disclosure, it should be understood that the disclosed apparatuses, devices and methods can be implemented in other ways. The device embodiments described above are only schematic. For example, the division of the unit is only a logical function division, and there may be other division methods in actual implementation. For example, a plurality of units or components may be combined or integrated into another apparatus, or some features may be ignored or not executed. On the other hand, the mutual coupling or direct coupling or communication connection shown or discussed may be indirect coupling or communication connection through some communication interfaces, devices or units, and may be electrical, mechanical or other forms.

The unit described as a separate part may or may not be physically separated, and the part displayed as a unit may or may not be a physical unit, that is, it may be located in one place or distributed to a plurality of network units. Some or all of the units may be selected according to actual needs to achieve the purpose of the present embodiments.

In addition, functional units in the various embodiments of the present disclosure may be integrated into one processing unit, or each unit may exist separately, or two or more units may be integrated into one unit.

If the functions are realized in the form of software functional units and sold or used as independent products, they can be stored in a non-volatile computer-readable storage medium executable by a processor. Based on this understanding, the technical solution of the present disclosure essentially, or a part of the technical solution of the present disclosure that contributes to the prior art, or a part of the technical solution can be embodied in the form of a software product, which is stored in a storage medium. The software product includes instructions to cause a computer device (which may be a personal computer, a server, or a network device, etc.) to perform all or part of the steps of the methods described in the various embodiments of the present disclosure. The aforementioned storage medium include: USB disk, mobile hard disk, read-only memory (ROM), random access memory (RAM), magnetic disc or optical disk and other media that can store program codes.

The above are only the specific embodiments of the present disclosure, and the protection scope of the present disclosure is not limited to this. Any person skilled in the art familiar with this technical field can easily think of changes or replacements within the scope of the present disclosure, which should be covered by the protection scope of the present disclosure. Therefore, the protection scope of the present disclosure shall be based on the protection scope of the claims.

1. A method for calibrating image acquiring devices, the method comprising:
obtaining a scene image of a preset scene acquired by an image acquiring device disposed on a traveling device, wherein the preset scene includes at least two parallel lines, the traveling device is located between adjacent two parallel lines among the at least two parallel lines, and sides of the traveling device are substantially parallel to the two parallel lines;
determining two line segments and a plurality of target reference points on each line segment of the two line segments based on the scene image, wherein the two line segments are respectively overlapped with two lines corresponding to the two parallel lines in the scene image;
determining, based on the scene image and for each line segment of the two line segments, first coordinate information of the plurality of target reference points on the line segment in a pixel coordinate system and second coordinate information of the plurality of target reference points on the line segment in a world coordinate system; and
determining a homography matrix corresponding to the image acquiring device based on the first coordinate information and the second coordinate information of the plurality of target reference points on each line segment of the two line segments.

2. The method according to claim 1, wherein, before obtaining the scene image of the preset scene acquired by the image acquiring device disposed on the traveling device, the method further comprises:
adjusting a position-orientation of the image acquiring device, such that a skyline included in the scene image acquired by the image acquiring device after the adjusting is located between a first reference line and a second reference line, wherein the first reference line and the second reference line are preset and located on a screen image of the image acquiring device when acquiring the scene image, and the first reference line and the second reference line are parallel on the screen image.

3. The method according to claim 2, wherein, before obtaining the scene image of the preset scene acquired by the image acquiring device disposed on the traveling device, the method further comprises:
adjusting the position-orientation of the image acquiring device, such that the skyline included in the scene image acquired by the image acquiring device after the adjusting is overlapped with a third reference line between the first reference line and the second reference line, wherein the third reference line is located on the screen image of the image acquiring device when acquiring the scene image, and is parallel to the first reference line and the second reference line on the screen image.

4. The method according to claim 1, wherein, before obtaining the scene image of the preset scene acquired by the image acquiring device disposed on the traveling device, the method further comprises:
adjusting a position-orientation of the image acquiring device, such that a skyline included in the scene image acquired by the image acquiring device after the adjusting is parallel or overlapped with a reference line, wherein the reference line is located on a screen image of the image acquiring device when acquiring the scene image.

5. The method according to claim 1, wherein determining the two line segments and the plurality of target reference points on each line segment of the two line segments based on the scene image comprises:
in a target area in the scene image, determining
the two line segments overlapped with the two lines corresponding to the two parallel lines in the scene image and
the plurality of target reference points on each line segment of the two line segments.

6. The method according to claim 1, wherein determining, based on the scene image and for each line segment of the two line segments, first coordinate information of the plurality of target reference points on the line segment in a pixel coordinate system and second coordinate information of the plurality of target reference points on the line segment in a world coordinate system comprises:
determining the first coordinate information of the plurality of target reference points in the pixel coordinate system corresponding to the scene image;
determining position coordinate information of an intersection of the two lines corresponding to the two parallel lines in the scene image in the pixel coordinate system based on the first coordinate information of the plurality of target reference points; and
determining the second coordinate information of the plurality of target reference points in the world coordinate system based on the position coordinate information of the intersection in the pixel coordinate system and the first coordinate information of the plurality of target reference points.

7. The method according to claim 6, wherein determining the second coordinate information of the plurality of target reference points in the world coordinate system based on the position coordinate information of the intersection in the pixel coordinate system and the first coordinate information of the plurality of target reference points comprises:
for each target reference point of the plurality of target reference points,
determining information of a difference between the first coordinate information of the target reference point and the position coordinate information of the intersection; and
determining the second coordinate information of the target reference point based on the information of the difference, focal length information of the image acquiring device, and a predetermined installation height of the image acquiring device.

8. The method according to claim 7, wherein the information of the difference between the first coordinate information of the target reference point and the position coordinate information of the intersection comprises an abscissa difference and an ordinate difference, and
wherein determining the second coordinate information of the target reference point based on the information of the difference, the focal length information of the image acquiring device and the predetermined installation height of the image acquiring device comprises:
determining a longitudinal coordinate value in the second coordinate information of the target reference point based on the ordinate difference, the predetermined installation height of the image acquiring device, and a longitudinal focal length in the focal length information of the image acquiring device; and
determining a horizontal coordinate value in the second coordinate information of the target reference point based on the longitudinal coordinate value, the abscissa difference, and a horizontal focal length in the focal length information of the image acquiring device.

9. The method according to claim 8, wherein determining the horizontal coordinate value in the second coordinate information of the target reference point based on the longitudinal coordinate value, the abscissa difference, and the horizontal focal length in the focal length information of the image acquiring device comprises:
determining a horizontal distance between the target reference point and the image acquiring device based on the longitudinal coordinate value, the abscissa difference, and the horizontal focal length in the focal length information of the image acquiring device; and
determining the horizontal coordinate value in the second coordinate information of the target reference point based on a determined horizontal distance between the image acquiring device and a center position of the traveling device, and the horizontal distance between the target reference point and the image acquiring device.

10. The method according to claim 1, wherein, after determining the homography matrix corresponding to the image acquiring device, the method further comprises:
obtaining a real-time image acquired by the image acquiring device in a moving process of the traveling device;
determining world coordinate information of a target object included in the real-time image in the world coordinate system based on the homography matrix corresponding to the image acquiring device and detected pixel coordinate information of the target object in the pixel coordinate system; and
controlling the traveling device based on the world coordinate information of the target object.

11. An electronic device, comprising:
at least one processor;
at least one memory; and
a bus,
wherein the at least one processor and the at least one memory are coupled to each other through the bus, and wherein the at least one memory stores machine-readable instructions executable by the at least one processor to perform operations comprising:
obtaining a scene image of a preset scene acquired by an image acquiring device disposed on a traveling device, wherein the preset scene includes at least two parallel lines, the traveling device is located between adjacent two parallel lines among the at least two parallel lines, and sides of the traveling device are substantially parallel to the two parallel lines;
determining two line segments and a plurality of target reference points on each line segment of the two line segments based on the scene image, wherein the two line segments are respectively overlapped with two lines corresponding to the two parallel lines in the scene image;
determining, based on the scene image and for each line segment of the two line segments, first coordinate information of the plurality of target reference points on the line segment in a pixel coordinate system and second coordinate information of the plurality of target reference points on the line segment in a world coordinate system; and
determining a homography matrix corresponding to the image acquiring device based on the first coordinate information and the second coordinate information of the plurality of target reference points on each line segment of the two line segments.

12. The electronic device according to claim 11, wherein, before obtaining the scene image of the preset scene acquired by the image acquiring device disposed on the traveling device, the operations further comprise:
adjusting a position-orientation of the image acquiring device, such that a skyline included in the scene image acquired by the image acquiring device after the adjusting is located between a first reference line and a second reference line, wherein the first reference line and the second reference line are preset and located on a screen image of the image acquiring device when acquiring the scene image, and the first reference line and the second reference line are parallel on the screen image.

13. The electronic device according to claim 12, wherein, before obtaining the scene image of the preset scene acquired by the image acquiring device disposed on the traveling device, the operations further comprise:
adjusting the position-orientation of the image acquiring device, such that the skyline included in the scene image acquired by the image acquiring device after the adjusting is overlapped with a third reference line between the first reference line and the second reference line, wherein the third reference line is located on the screen image of the image acquiring device when acquiring the scene image, and is parallel to the first reference line and the second reference line on the screen image.

14. The electronic device according to claim 11, wherein, before obtaining the scene image of the preset scene acquired by the image acquiring device disposed on the traveling device, the operations further comprise:
adjusting a position-orientation of the image acquiring device, such that a skyline included in the scene image acquired by the image acquiring device after the adjusting is parallel or overlapped with a reference line, wherein the reference line is located on a screen image of the image acquiring device when acquiring the scene image.

15. The electronic device according to claim 11, wherein determining the two line segments and the plurality of target reference points on each line segment of the two line segments based on the scene image comprises:
in a target area in the scene image, determining
the two line segments overlapped with the two lines corresponding to the two parallel lines in the scene image and
the plurality of target reference points on each line segment of the two line segments.

16. The electronic device according to claim 11, wherein determining, based on the scene image and for each line segment of the two line segments, first coordinate information of the plurality of target reference points on the line segment in a pixel coordinate system and second coordinate information of the plurality of target reference points on the line segment in a world coordinate system comprises:
determining the first coordinate information of the plurality of target reference points in the pixel coordinate system corresponding to the scene image;
determining position coordinate information of an intersection of the two lines corresponding to the two parallel lines in the scene image in the pixel coordinate system based on the first coordinate information of the plurality of target reference points; and
determining the second coordinate information of the plurality of target reference points in the world coordinate system based on the position coordinate information of the intersection in the pixel coordinate system and the first coordinate information of the plurality of target reference points.

17. The electronic device according to claim 16, wherein determining the second coordinate information of the plurality of target reference points in the world coordinate system based on the position coordinate information of the intersection in the pixel coordinate system and the first coordinate information of the plurality of target reference points comprises:
for each target reference point of the plurality of target reference points,
determining information of a difference between the first coordinate information of the target reference point and the position coordinate information of the intersection; and
determining the second coordinate information of the target reference point based on the information of the difference, focal length information of the image acquiring device and a predetermined installation height of the image acquiring device.

18. The electronic device according to claim 17, wherein the information of the difference between the first coordinate information of the target reference point and the position coordinate information of the intersection comprises an abscissa difference and an ordinate difference, and
wherein determining the second coordinate information of the target reference point based on the information of the difference, the focal length information of the image acquiring device and the predetermined installation height of the image acquiring device comprises:
determining a longitudinal coordinate value in the second coordinate information of the target reference point based on the ordinate difference, the predetermined installation height of the image acquiring device, and a longitudinal focal length in the focal length information of the image acquiring device; and
determining a horizontal coordinate value in the second coordinate information of the target reference point based on the longitudinal coordinate value, the abscissa difference, and a horizontal focal length in the focal length information of the image acquiring device.

19. The electronic device according to claim 18, wherein determining the horizontal coordinate value in the second coordinate information of the target reference point based on the longitudinal coordinate value, the abscissa difference, and the horizontal focal length in the focal length information of the image acquiring device comprises:
determining a horizontal distance between the target reference point and the image acquiring device based on the longitudinal coordinate value, the abscissa difference, and the horizontal focal length in the focal length information of the image acquiring device; and
determining the horizontal coordinate value in the second coordinate information of the target reference point based on a determined horizontal distance between the image acquiring device and a center position of the traveling device, and the horizontal distance between the target reference point and the image acquiring device.

20. A non-transitory computer-readable storage medium storing one or more computer programs executable by at least one processor to perform operations comprising:
obtaining a scene image of a preset scene acquired by an image acquiring device disposed on a traveling device, wherein the preset scene includes at least two parallel lines, the traveling device is located between adjacent two parallel lines among the at least two parallel lines, and sides of the traveling device are substantially parallel to the two parallel lines;
determining two line segments and a plurality of target reference points on each line segment of the two line segments based on the scene image, wherein the two line segments are respectively overlapped with two lines corresponding to the two parallel lines in the scene image;
determining, based on the scene image and for each line segment of the two line segments, first coordinate information of the plurality of target reference points on the line segment in a pixel coordinate system and second coordinate information of the plurality of target reference points on the line segment in a world coordinate system; and
determining a homography matrix corresponding to the image acquiring device based on the first coordinate information and the second coordinate information of the plurality of target reference points on each line segment of the two line segments.
